(19) United States
(12) Patent Application Publication
(10) Pub. No.: US 2024/0174575 A1
(43) Pub. Date: May 30, 2024

(54) FABRICATION OF FLUID DEVICES AND FLUID DEVICES PRODUCED

(71) Applicant: CORNING INCORPORATED, CORNING, NY (US)

(72) Inventors: George Edward Berkey, Pine City, NY (US); Alexander Lee Cuno, Sayre, PA (US); James Scott Sutherland, Painted Post, NY (US)

(21) Appl. No.: 18/283,239

(22) PCT Filed: Mar. 21, 2022
(86) PCT No.: PCT/US2022/021132

§ 371 Date: Sep. 21, 2023

Related U.S. Application Data
(60) Provisional application No. 63/166,612, filed on Mar. 26, 2021.

(51) Int. Cl. C04B 35/565; B01J 19/00; B28B 3/02; B28B 7/18; B28B 7/34; C04B 35/628; C04B 35/645; F28F 7/02

(52) U.S. Cl. CPC C04B 35/565; B01J 19/0093; B28B 3/025; B28B 7/18; B28B 7/342; C04B 35/62802; C04B 35/6455; F28F 7/02; B01J 2219/0079; B01J 2219/00824; B01J 2219/00855; B01J 2219/0086; C04B 2235/3826; C04B 2235/6028; C04B 2235/786; C04B 2235/945; C04B 2235/95; C04B 2235/963; F28F 2210/02

(57) ABSTRACT

A device and a process for forming a monolithic substantially closed-porosity ceramic fluidic device having a tortuous fluid passage extending through the device, the tortuous fluid passage having a smooth interior surface, a material of the ceramic body having a continuous and uniform distribution of grains at least between opposed major surfaces of the ceramic body. The process includes positioning a positive fluid passage mold within a volume of binder-coated ceramic powder, pressing the volume of ceramic powder with the mold inside to form a pressed body, heating the pressed body to remove the mold, and sintering the pressed body. A relationship between a first stability characteristic of the volume of ceramic powder and a second stability characteristic of the mold prevents discontinuities in the pressed body after pressing and/or during heating.

### CROSS-REFERENCE TO RELATED APPLICATIONS

This application claims the benefit of priority under 35 U.S.C. § of U.S. Provisional Application No. 63/166,612, filed Mar. 26, 2021, the content of which is incorporated herein by reference in its entirety.

### FIELD OF THE DISCLOSURE

The disclosure relates to methods of fabrication ceramic structures with directed porosity, and more particularly to methods fabrication of high density, closed-porosity monolithic ceramic structures, particularly high density, closed-porosity monolithic silicon carbide fluid devices, with smooth-surfaced tortuous internal passages extending through or within the structures or devices, and to the structures or fluid devices themselves.

### BACKGROUND

Silicon carbide ceramic (SiC) is a desirable material for fluidic modules for flow chemistry production and/or laboratory work and for structures for other technical uses. SiC has relatively high thermal conductivity, useful in performing and controlling endothermic or exothermic reactions. SiC has good physical durability and thermal shock resistance. SiC also possesses extremely good chemical resistance. But these properties, combined with high hardness and abrasiveness, make the practical production of SiC structures with internal features, such as SiC flow modules with tortuous internal passages, challenging.

Flow reactors and other structures formed of SiC are often prepared via a sandwich assembly approach. Green ceramic bodies are pressed into slabs and then shaped, generally on one major surface, using CNC machining, molding, or pressing operations, or the like. After green body firing, two fired slabs are joined, shaped surfaces facing each other, with an intermediate joining layer of ceramic material or without such a joining layer (the latter of which is sometimes referred to as diffusion bonding). In a second firing step the joint is fused (and/or the joining layer densifies) to produce a body with one or more internal channels.

The sandwich assembly joining approach can introduce problems in the fabricated fluidic modules. In modules joined having an intermediate layer, porous interfaces may form at the joining layer. These may trap liquids causing potential for contamination/difficulty cleaning and for mechanical failure (such as by freezing in the pores). Modules joined without intermediate joining layers via diffusion bonding have required or resulted in inclusion of relatively coarse ceramic grains, producing internal channel surfaces with an undesirable level of roughness.

In another approach, multiple layers of green-state SiC sheets can be produced and cut to shapes required to build up a fluidic module slice-by-slice. Such an approach tends to produce small step-like structures in curved profiles of internal passages. For emptying and cleaning/purging of fluidic modules, the wall profiles of internal passages are desirably smooth and free from small step-like structures.

Accordingly, there is a need for SiC fluidic modules and other SiC structures, and methods of fabricating SiC fluidic modules and other SiC structures, with internal passages having improved internal-passage surface properties, specifically: low porosity generally, or no significant porous interfaces at a seal location, low surface roughness, and smooth wall profiles.

### SUMMARY OF THE DISCLOSURE

According to some aspects of the present disclosure, a monolithic substantially closed-porosity SiC structure, such as a fluidic module, is provided, having a tortuous fluid passage extending within the structure or through the module, the tortuous fluid passage having an interior surface, the interior surface having a surface roughness in the range of from 0.1 to 80 μm Ra.

According to some additional aspects of the present disclosure, a process for forming a monolithic substantially closed-porosity SiC structure or fluidic module is provided, the process comprising positioning a positive mold such as a positive fluid passage mold within a volume of SiC powder, the powder coated with a binder; pressing the volume of SiC powder with the mold inside to form a pressed body; heating the pressed body to remove the mold; and sintering the pressed body to form a monolithic SiC structure or fluidic module having a tortuous fluid passage within or extending therethrough.

The structure or module of the present disclosure has very low open porosity (as low as 0.1% or less) and low roughness of the tortuous passage interior surface (as low as 0.1 μm Ra). This provides a structure or fluidic module with an internal passage resistant to infiltration by fluids. For flow modules, the module is thus easily cleanable, with low pressure drop during use. During use, fluidic boundary layers near the smooth interior wall surface of the flow modules are thin relative to boundary layers resulting from rougher surfaces, providing better mixing and heat exchange performance.

According to further aspects of the present disclosure, a process for forming a SiC structure or more specifically, a SiC fluidic module for a flow reactor is provided. The process comprises positioning a positive mold such as a fluid passage mold of a passage having a tortuous shape within a volume of binder-coated SiC powder, pressing the volume of SiC powder with the mold inside to form a pressed body, heating the pressed body to remove the mold; and sintering the pressed body to form a monolithic SiC fluidic module having a tortuous fluid passage extending therethrough. The pressing can comprise uniaxial pressing. The pressing can comprise isostatic pressing in an isostatic press. The heating the pressed body to remove the mold can comprise a second or a continued pressing the pressed body while heating the pressed body. Where the initial pressing is performed in an isostatic press, the second or continued pressing may be performed in the same press.

The process can also include, before sintering the pressed body, debinding the pressed body. The process can also include forming a positive passage mold of a passage having a tortuous shape by molding the passage mold, or by 3-D printing the passage mold. According to one alternative, forming the positive passage mold may also include forming a positive passage mold having an outer layer of lower melting material, the lower melting material having a melting point lower than a melting point of a remainder of the positive passage mold. The melting point of the lower melting material can be lower than the melting point of the remainder of the positive passage mold by at least 5° C.

The disclosed methods and variations thereof allow the practical production of the SiC structures, such as SiC fluidic modules, having the desirable features mentioned above.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, explain, by way of example, principles and operation of the disclosure. It is to be understood that various features of the disclosure disclosed in this specification and in the drawings can be used in any combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a diagrammatic plan view outline of a fluid passage of a type useful in fluid devices showing certain features of the fluid passage;

FIG. 2 is a perspective external view of an embodiment of a fluid device of the present disclosure;

FIG. 3 is a diagrammatic cross-sectional view of an embodiment of a fluid device of the present disclosure;

FIG. 4 is a flow chart showing some embodiments of a method for producing a fluid device of the present disclosure;

FIG. 5 is a stepwise series of cross-sectional representations of some embodiments of the method(s) described in FIG. 4;

FIG. 6 is a graph illustrating compression release curves useful in practicing the methods of the present disclosure;

FIG. 7 is a cross-sectional representation of an embodiment of an apparatus for performing the pressing step and/or the demolding step of the method of FIG. 4;

FIG. 8 is a flow chart of an embodiment of a process by which demolding can be performed with pressure applied through a fluid-tight bag enclosing a green state powder pressed ceramic body;

FIG. 9 is a cross-sectional representation of an embodiment of an apparatus for use in performing the pressing step and/or the demolding step of the method of FIG. 4 and or the demolding of FIG. 8;

FIGS. 10 and 11 are cross-sectional representations of forms the green state powder pressed ceramic body and mold material may take during and after demolding such as by the process according to FIG. 8;

FIG. 12 is a cross section of an additional or alternative embodiment of elements of the apparatus of FIG. 9;

FIG. 13 is a cross section of another additional or alternative embodiment of elements of the apparatus of FIG. 9;

FIG. 14 is a cross section of yet another additional or alternative embodiment of elements of the apparatus of FIG. 9;

FIG. 15 is a cross section of still another additional or alternative embodiment of elements of the apparatus of FIG. 9;

FIG. 16 is a cross section of still one more additional or alternative embodiment of elements of the apparatus of FIG. 9;

FIGS. 17-19 are graphs illustrating compression and/or release curves of candidate materials for a fluid passage mold useful in practicing the methods of the present disclosure;

FIG. 20 is an X-ray computed tomography image of a cross section of a SiC fluid device along a section plane, such as the section plane shown in FIG. 2, showing a microstructure the fluid device;

FIG. 21 is a cross-sectional image of a prior art fluidic module formed using a sandwich assembly approach, showing a joint with reduced density between the joined SiC bodies of the module;

FIG. 22 is a scanning electron microscopy (SEM) image of a sample of sintered SiC material processed according to the methods of the present disclosure; and

FIG. 23 is a photomicrograph image of a sample of sintered SiC material processed according to the conventional diffusion bonding approach.

### DETAILED DESCRIPTION OF THE PREFERRED EMBODIMENTS

Additional features and advantages will be set forth in the detailed description which follows and will be apparent to those skilled in the art from the description or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an endpoint of a range, the disclosure should be understood to include the specific value or endpoint referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, a “tortuous” passage refers to a passage having no line of sight directly through the passage and with a path of the passage having at least two differing radii of curvature, the path of the passage being defined mathematically and geometrically as a curve formed by successive geometric centers, along the passage, of successive minimum-area planar cross sections of the passage (that is, the angle of a given planar cross section is the angle which produces a minimum area of the planar cross section at the particular location along the passage) taken at arbitrarily closely spaced successive positions along the passage. Typical machining-based forming techniques are generally inadequate to form such a tortuous passage. Such passages may include a division or divisions of a passage into subpassages (with corresponding subpaths) and a recombination or recombinations of subpassages (and corresponding subpaths).

As used herein a “monolithic” SiC structure does not imply zero inhomogeneities in the ceramic structure at all scales. A “monolithic” SiC structure or a “monolithic” SiC fluidic module, as the term “monolithic” is defined herein, refers to a SiC structure or fluidic module, with one or more tortuous passages extending therethrough, in which no (other than the passage(s)) inhomogeneities, openings, or interconnected porosities are present in the ceramic structure having a length greater than the average perpendicular depth d of the one or more passages P from the external surface of the structure or module 300, as shown in FIG. 3. For SiC structures or SiC fluidic modules with other geometries, such as non-planar or circular geometries, the term “monolithic” refers to a SiC structure or fluidic module, with one or more tortuous passages extending therethrough, in which no (other than the passage(s)) inhomogeneities, openings, or interconnected porosities are present in the ceramic structure having a length greater than (i) the minimum depth of the one or more passages P from the external surface of the structure or module and (ii) the minimum spacing between separate, spaced-apart portions of the one or more passages P from one another. Fluidic ports that are machined and/or molded in the structure or module so as to intentionally enable fluid communication from the outside of the structure or module to the passages and/or between separate, spaced-apart portions of the passages, such as inlet ports and/or outlet ports, are excluded from the determination of the average perpendicular depth, the minimum depth, and/or the minimum spacing. Providing such a monolithic SiC structure or monolithic SiC flow module helps ensure fluid tightness and good pressure resistance of a flow reactor fluidic module or similar product.

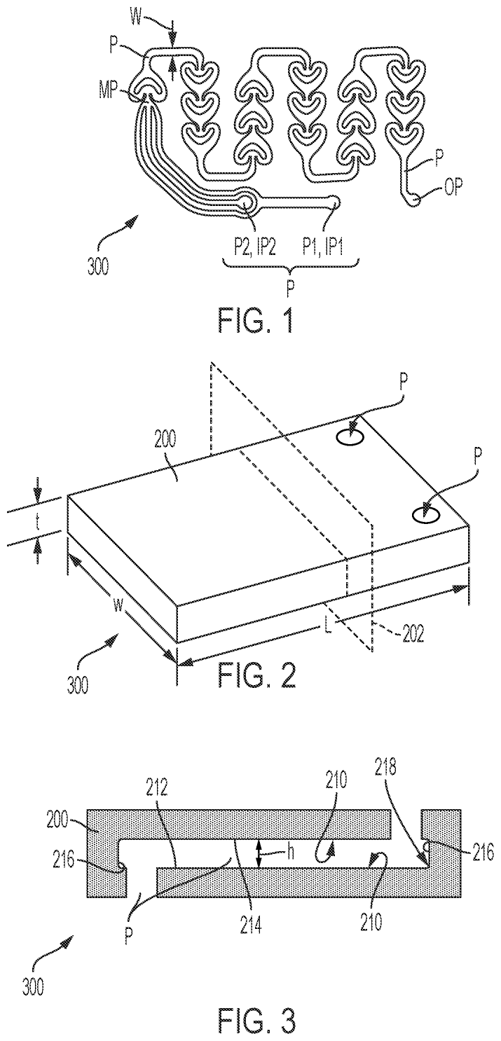

A fluidic device 300 for a flow reactor (not shown) is disclosed in FIGS. 1-3. The fluidic device 300 comprises a monolithic closed-porosity ceramic body 200 and a tortuous fluid passage P extending along a path through the ceramic body 200. The ceramic body 200 is formed from a ceramic material that includes any pressable powder that is held together by a binder and thermally processed to fuse the powder particles together into a structure. The ceramic material in some embodiments includes oxide ceramics, non-oxide ceramics, glass-ceramics, glass powders, metal powders, and other ceramics that enable high density, closed-porosity monolithic structures. Oxide ceramics are inorganic compounds of metallic (e.g., Al, Zr, Ti, Mg) or metalloid (Si) elements with oxygen. Oxides can be combined with nitrogen or carbon to form more complex oxynitride or oxycarbide ceramics. Non-oxide ceramics are inorganic, non-metallic materials and include carbides, nitrides, borides, silicides and others. Some examples of non-oxide ceramics that can be used for the ceramic body 200 include boron carbide (B₄C), boron nitride (BN), tungsten carbide (WC), titanium diboride (TiB₂), zirconium diboride (ZrB₂), molybdenum disilicide (MoSi₂), silicon carbide (SiC), silicon nitride (Si₃N₄), and sialons (silicon aluminum oxynitrides). The ceramic body 200 in the exemplary embodiment is formed from SiC.

The tortuous fluid passage P has an interior surface 210. The interior surface 210 has a surface roughness in the range of from 0.1 to 80 μm Ra, or 0.1 to 50, 0.1 to 40, 0.1 to 30, 0.1 to 20, 0.1 to 10, 0.1 to 5, or even 0.1 to 1 μm Ra, which is generally lower than SiC fluidic devices have previously achieved. The surface roughness of the interior surface 210 exists along any measured profile of the interior surface 210. For instance, when viewed in a planar cross section oriented normal to the path, the interior surface 210 defines an interior profile that completely encircles the path of the passage P. The surface roughness of the interior surface 210 exists along an entirety of the interior profile at every position along the path. The interior surface 210 also has no joints or seams or steps or discontinuities along the interior surface 210 due to the monolithic structure of the ceramic body 200.

According to further embodiments, the ceramic body 200 of the fluidic device 300 has a density of at least 95% of a theoretical maximum density of the ceramic material, or even of at least 96, 97, 98, or 99% of the theoretical maximum density. The theoretical maximum density (also known as maximum theoretical density, theoretical density, crystal density, or x-ray density) of a polycrystalline material, such as SiC, is the density of a perfect single crystal of the sintered material. Thus, the theoretical maximum density is the maximum attainable density for a given structural phase of the sintered material.

In the exemplary embodiment, the ceramic material is α-SiC with a hexagonal 6H structure. The theoretical maximum density of sintered SiC(6H) is 3.214±0.001 g/cm³. Munro, Ronald G., “Material Properties of a Sintered α-SiC,” Journal of Physical and Chemical Reference Data, 26, 1195 (1997). The ceramic material in other embodiments includes a different crystalline form of SiC or a different ceramic altogether. The theoretical maximum density of other crystalline forms of sintered SiC can differ from the theoretical maximum density of sintered SiC(6H), for example, within a range of 3.166 to 3.214 g/cm³. Similarly, the theoretical maximum density of other sintered ceramics also differs from that of sintered SiC(6H). As used herein, a “high density” ceramic body is a ceramic body in which the sintered ceramic material of the ceramic body has a density that of at least 95% of the theoretical maximum density of the ceramic material.

According to embodiments, the ceramic body 200 of the fluidic device 300 has an open porosity of less than 1%, or even of less than 0.5%, 0.4%, 0.2% or 0.1%. The ceramic body 200 in embodiments has a closed porosity of less than 3%, or less than 1.5%, or even less than 0.5%. As used herein, a “closed-porosity” ceramic body is a ceramic body in which the ceramic material of the ceramic body exhibits a pore topology that is closed such that the pores or cells in the material are isolated or connected only with adjacent pores or cells and have no permeability to fluid.

According to still further embodiments, the ceramic body 200 of the device 300 has an internal pressure resistance under pressurized water testing of at least 50 bar, or even at least 100 bar, or 150 bar.

The tortuous fluid passage P, according to embodiments, comprises a floor 212 and a ceiling 214 separated by a height h and two opposing sidewalls 216 joining the floor 212 and the ceiling 214. The sidewalls are separated by a width w (FIG. 1) measured perpendicular to the height h and the direction along the passage (corresponding to the predominant flow direction when in use). Further, width w is measured at a position corresponding to one-half of the height h. According to embodiments, the height h of the tortuous fluid passage is in the range of from 0.1 to 20 mm, or from 0.2 to 15, or 0.3 to 12 mm.

According to embodiments, the interior surface 210 of the fluid passage P where the sidewalls 216 meet the floor 212 has a radius curvature (at reference 218) of greater than or equal to 0.1 mm, or greater than or equal to 0.3, or even greater than or equal to 0.6 mm, or 1 mm or 1 mm, 1 cm or 2 cm.

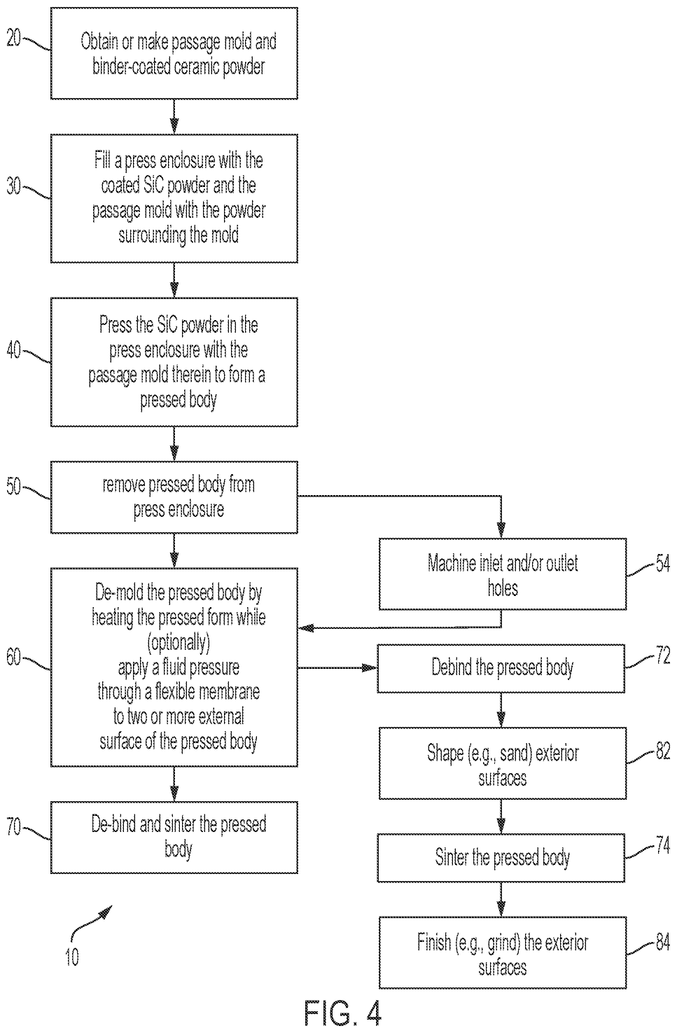

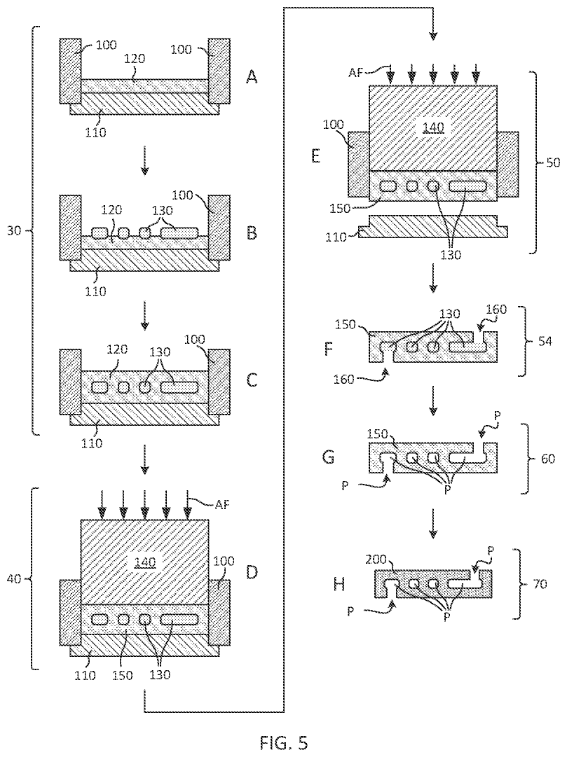

Due to the process for forming the fluidic device 300 as described below with reference to FIGS. 4 and 5, the interior profile of the interior surface 210 when viewed in a planar cross section oriented normal to the path can have any cross-sectional shape suitable for conveying fluids through the tortuous fluid passage P. For example, the interior profile can have a quadrilateral cross-sectional shape, such as a square or rectangular shape, with fillets 218 at the intersections of the sidewalls 216 with the floor 212 or with the ceiling 214 as described above with reference to FIG. 3. The interior profile can have a circular cross-sectional shape, which enables higher pressure resistance. The interior profile can have a cross-sectional shape that is neither circular nor polygonal, for example, an oval cross-sectional shape. For such geometries, the hydraulic diameter of the cross-section can provide a parameter for describing the geometry of the interior profile and its relation to the flow through the tortuous fluid passage P.

With reference to FIGS. 4 and 5, according to embodiments, a process for forming a SiC device for a flow reactor having one or more of these or other desirable properties can include the step 20 of obtaining or making a passage mold and a binder-coated SiC powder (such powders are commercially available from various suppliers such as those indicated below). The passage mold can be obtained by molding, machining, 3D printing, or other suitable forming techniques or combinations thereof. The material of the passage mold is desirably a relatively incompressible material. The material of the passage mold can be a thermoplastic material.

The process further can include the step of (partially) filling a press enclosure (or die) 100, the press enclosure 100 being closed with a plug 110, with binder-coated SiC powder 120, as described in step 30 of FIG. 4 and as represented in the cross section of FIG. 5A. Next, the passage mold 130 is placed on/in the SiC powder 120 (FIG. 5B) and an additional amount of SiC powder is put on top of the passage mold 130, such that the SiC powder 120 surrounds the passage mold 130 (FIG. 5C, step 30 of FIG. 4). Next, a piston or ram 140 is inserted in the press enclosure 100 and a uniaxial force AF is applied from above to compress the SiC powder 120 with the passage mold 130 inside (FIG. 5D and FIG. 4 step 40) to form a pressed body 150. The force AF applied by the ram 140 is configured to generate a maximum pressure of 35-40 MPa on the SiC powder. The maximum pressure can vary in further embodiments in which the binder-coated powder and the passage mold are formed, respectively, from different materials. A reaction force or equal counteracting force AF (not shown) is supplied at the plug 110 during this step.) Next, with plug 110 now free to move, the pressed body 150 is removed by a (smaller) force AF applied to the piston 140 (FIG. 5E, step 50 of FIG. 4).

Next, the pressed body 150, now free from the press enclosure 100, is machined in selected locations, such as by drilling, to form holes or fluidic ports 160 extending from the outside of the pressed body 150 to the passage mold 130 (FIG. 5F, step 54 of FIG. 4). Note that this is an optional step, because the holes can, in another alternative, be formed using a mold which includes the shape of the holes or fluidic ports as part of the mold. Also, as still another variation, drilling may be postponed and used as part of the de-molding step 60 described below.

Next, the pressed body 150 is heated, preferably at a relatively high rate, such that the passage mold 130 is melted and removed from the pressed body 150 by flowing out of the pressed body 150, and/or by being blown and/or sucked out in addition. (FIG. 5G, step 60 of FIG. 4). In yet another alternative, this step 60 can be divided into two parts, where first the pressed body is heated, and then next, separately, the mold material can flow out of the body. It is also possible, in yet another alternative to de-mold the sample by heating the pressed body 150 to melt mold, and only then drill holes or fluidic ports, while the body is still hot, allowing the mold material to flow out and complete demolding in this manner. The heating may be under partial vacuum, if desired.

Finally, the pressed body 150 is de-bound to remove SiC powder binder, and then fired (sintered) to densify and further solidify the pressed body into a monolithic SiC body 200. (FIG. 5H, step 70 of FIG. 4).

As shown in the flowchart of FIG. 4, additional or alternative steps can include step 72, debinding, step 82, shaping or preliminarily shaping the exterior surface(s), such as by sanding or other machining before sintering, and step 84, finishing the exterior surface(s), such as by grinding, after sintering.

Sintering can be performed as specified or recommended by the supplier of the coated SiC powder. Such suppliers include, for example, Panadyne Inc. (Montgomeryville, PA, USA), GNP Ceramics (Buffalo, NY, USA), H. C. Starck (Hermsdorf, Germany), and IKH (Industriekeramik Hochrhein GmbH) (Wutöschingen, Germany). One example of a debinding and firing cycles (performed in succession in one chamber or individually) can include three steps: (1) curing of the binder, such as at a temperature of 150+/−25° C., in air, to strengthen or stiffen the binder; (2) debinding at 600+/−25° C., in a non-oxygenating environment such as in N₂; and (3) sintering at 2100+/−50° C. in a non-oxygenating environment, such as in Ar. An example of a time, temperature, gas, and ramp rate table is given in the Table below:

TABLE

| Total time | Segment | Target | Heating | |
|---|---|---|---|---|
| (hr) | time (hr) | temperature (° C.) | Rate (° C./min) | Ambient gas |
| 0.0 | 0 | 25 | | Air |
| 2.3 | 2.3 | 150 | 2 | Air |
| 5.3 | 3.0 | 150 | 3 | Air |
| 7.8 | 2.5 | 600 | 2 | N2 |
| 10.8 | 3.0 | 600 | 3 | N2 |
| 15.6 | 4.8 | 25 | 2 | N2 |

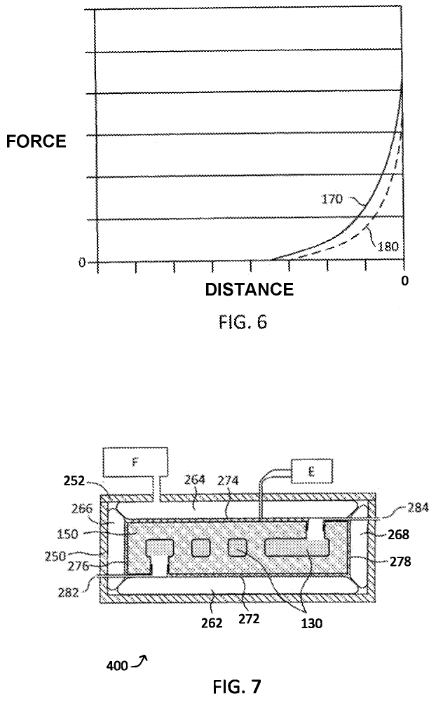

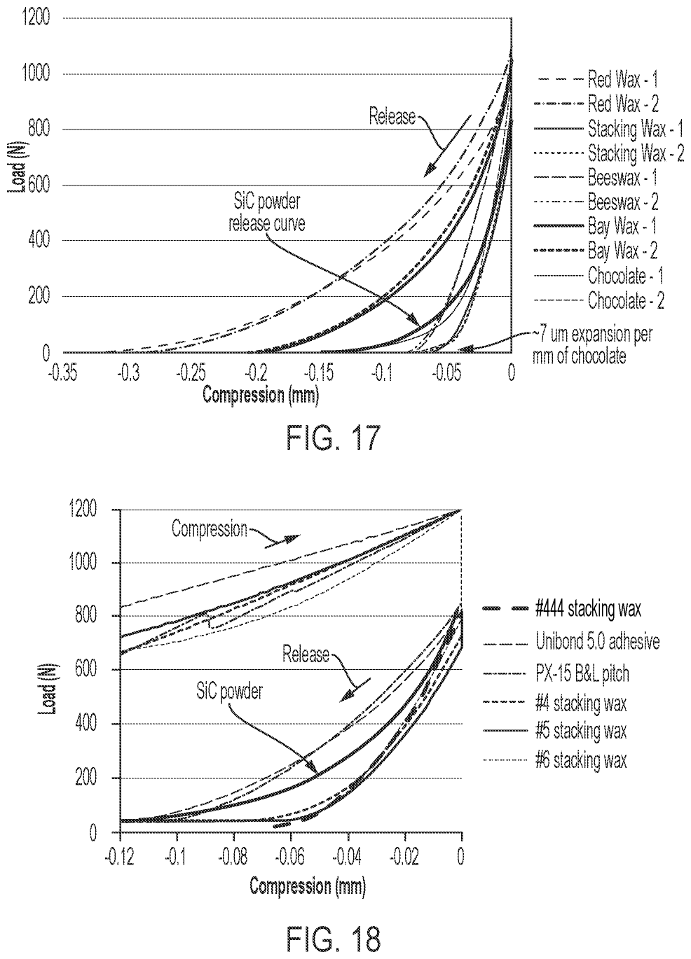

FIG. 6 is a graph illustrating compression release curves useful in practicing the methods of the present disclosure. The curves in the graph show a desirable relationship between a first stability characteristic of the SiC powder 120 and a second stability characteristic of the passage mold 130. In practice, the compression release curves can be generated experimentally by pressing a respective sample of a ceramic powder or a passage mold with a press to a measured maximum force and then reducing the displacement of the press while continuing to measure the reaction force generated by the sample. Some such experiments are described later with reference to FIGS. 17-19. As a result of the first stability characteristic, the SiC powder 120 expands or rebounds from a maximum compressed state over a displacement that follows the compression release curve 170 of FIG. 6 to define a first release displacement. Similarly, as a result of the second stability characteristic, the passage mold 130 expands or rebounds from a maximum compressed state over a displacement that follows the compression release curve 180 of FIG. 6 to define a second release displacement. The compression release curves 170 and 180 are graphed in units of distance (x axis) versus force (y axis).

The curvature of the force-displacement curve to the left as it drops is an indication of how much stored energy is released from the samples during the release phase. To simplify comparison of the samples, the force-displacement curve for each sample are shifted so that the release phase curves are aligned at initial release. The leftward trend in the curves corresponds to the upward motion of the press and the concurrent reduction in reaction force on the press. It is preferable that the first release displacement of the SiC powder material 120 along the compression release curve 170 is greater than the second release displacement of the material of the passage mold 130 along the compression release curve 180. The first release displacement is preferably greater than the second release displacement along an entirety of the compression release curves 170 and 180. Such a relationship between the first and second release displacements is beneficial to prevent discontinuities, such as cracks, in the pressed body 150 after pressing, during heating, or after pressing and during heating.

The compression displacement along the compression curve, not shown, is not particularly significant. But using a relatively incompressible mold material such that the SiC release displacement is greater than the passage mold release displacement helps maintain the structural integrity of the pressed body during steps after pressing. Further, to achieve the smooth internal passage walls, coated SiC powder with generally smaller particle sizes is preferred, as are passage mold materials having generally higher hardness.

In further embodiments, the second release displacement of the material of the passage mold 130 can be greater than the first release displacement of the SiC powder 120 along portions or an entirety of the compression release curves 170 and 180. With this relationship between the first and second release displacements, the material of the passage mold 130 can expand more than the SiC powder 130 after pressing such that the passage mold 130 exerts a force on the pressed SiC body surrounding it. A tensile strain can be produced in the SiC powder when the expansion of the passage mold 130 is greater than the expansion of the SiC powder 120. If the tensile strain exceeds the ultimate tensile strength of the green pressed SiC powder, cracks can appear in the SiC powder adjacent to the passage mold 130.

To address this undesirable result, the first stability characteristic of the SiC powder 120 can further include a binder strength that is configured to counteract a release force of the passage mold 130 after pressing. The binder-coated SiC powder 120 is formed of submicrometer SiC powder clustered together in granules that are 50-200 μm in diameter using a spray dry process and includes particles of α-SiC with a hexagonal 6H structure, which are surrounded by a binder. The binder strength of a binder relates to the type of binder and the amount of binder. The binder strength of a binder can be characterized by its effect on the tensile strength of a green body. The tensile strength of green pressed spray-dried SiC powders can be measured using a Crack Opening Displacement (COD) Test, as described in ASTM E399-09. A non-exhaustive list of binders that can be used includes phenolic resin, phenol, formaldehyde, coal tar pitch, polymethylmethacrylate, methyl methacrylate, wax, polyethylene glycol, acetic acid, ethenyl ester, carbon black, and triethanolamine. In one embodiment, the SiC(6H) particles are coated with a phenolic resin binder. The amount of binder is low enough to achieve the high density, closed-porosity ceramic body after sintering.

Another issue related to crack formation can arise during heating of the pressed body to melt the passage mold 130 and remove it from pressed body. Specifically, volumetric expansion of the passage mold 130 on melting (typically 10-30 vol %) can induce stress on the green SiC pressed body. In some situations, this induced stress can lead to crack formation in regions immediately adjacent to the passages if the induced stress is not counteracted. In further embodiments, the binder strength of the binder-coated SiC powder 120 is configured to counteract a force of the passage mold 130 on the pressed body during heating of the pressed body to remove the passage mold 130. For instance, the binder strength of the binder-coated SiC powder 120 is increased or set such that a tensile strength of the green pressed SiC powder is sufficient to counteract the forces generated during the heating/demolding processes that would otherwise induce cracks in the green body.

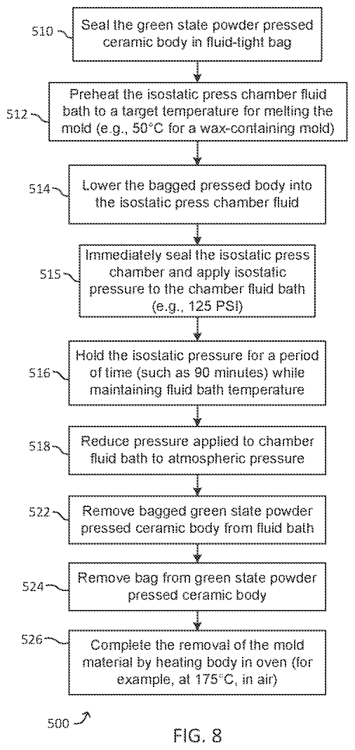

FIG. 7 shows in a cross-sectional representation one an embodiment of an apparatus 400 for performing the demolding step 60 of FIG. 4 while applying pressure to the outside of the pressed body 150, or optionally, for performing the pressing step 40, or optionally, for performing both the pressing step 40 and the demolding step 60.

As used for embodiments of the demolding step 60 in which pressure is applied to the pressed body 150 during demolding, the apparatus 400 is in the form of a press or optionally of an isostatic or quasi-isostatic press and comprises an openable and closeable frame 250, such as with a lid 252 or other means of opening and closing, and with an interior and exterior. One or more flexible membranes 262, 264, 266, 268 are positioned within the frame 250 and have a first surface facing the interior of the frame 250 and a second surface (directly) opposite the first surface, the second surface forming at least part of an enclosed volume having fluid lines, connections, ports, or the like, connected or to be connected to a supply of pressurized fluid F. The apparatus 400 also optionally includes a clearance or a pathway or a port or conduit 282, 284 or the like through which the material of a mold 130 can drain when melted from the from a green state powder pressed ceramic body 150 while a pressure is applied to the green state powder pressed ceramic body 150 by a fluid, through the one or more flexible membranes 262, 264, 266, 268. The fluid supplied by fluid source F can be, according to embodiments, a heated liquid which supplies energy to the mold material by heating the green state powder pressed ceramic body 150.

In alternative embodiments, the fluid source F may supplied gas under pressure such as compressed air or nitrogen, and the apparatus 400 can also include one or more flexible heating pads 272, 274, 276, 278 positioned on the first surface of the one or more flexible membranes 262, 264, 266, 268. A flexible heating pad of the apparatus can comprise (1) multiple zones in which input energy can be individually controlled and/or (2) multiple individually energizable smaller heating pads, not shown, to which energy can be supplied by a source E of electrical energy.

In operation for demolding, in the apparatus of FIG. 7 or similar embodiments, energy is applied to the internal mold 130 within the green state powder pressed ceramic body 150 to melt a material of the internal mold while at the same time a fluid pressure is applied through one or more flexible membranes to at least two opposite external surfaces (to the two largest surfaces) of the green state powder pressed ceramic body 150, while one or more of (1) allowing the melted mold material to drain from green state powder pressed ceramic body, (2) blowing the melted mold material from green state powder pressed ceramic body, and (3) sucking the melted mold material from green state powder pressed ceramic body to remove the mold. Alternatively, the mold material may be melted while the pressed body 150 is under pressure, but the melted mold material can be allowed to flow out after the pressure is removed, such as after the pressed body 150 is removed from the apparatus 400. Energy can be applied to the internal mold by heating the mold by heating the green state powder pressed ceramic body. If equal pressure is applied to every side of the green state powder pressed ceramic body, such as by having individual flexible membranes on every side, isostatic or quasi-isostatic pressure can be applied.

According to additional alternative aspects of the present invention, the press apparatus 400 of FIG. 7 may be used, alternatively or in addition, to perform the pressing step 40 of the method of FIG. 4. During such pressing, the SiC powder (before pressing) or the resulting pressed body (during and after pressing) is not heated because the mold should remain solid and unmelted during the pressing step 40. Pressures in the range of from 10 MPa to 300 MPa, desirably 20 MPa to 150 MPa or more specifically 30 MPa to 50 MPa may be used during pressing, while pressures during demolding are much lower, desirably in the range of from 0.3 MPa to 20 MPa, 1 MPa to 10 MPa, or most specifically from 3 MPa to 5 MPa. Accordingly, if apparatus 400 is used for both pressing and demolding, there should be a depressurization from the high pressure used for pressing to the lower pressure used for demolding generally before any significant heating of the mold takes place.

According to additional embodiments of the present invention, the flexible membrane through which pressure is applied for demolding or both pressing and demolding may take the form of a fluid-tight bag enclosing the green state powder pressed ceramic body—as is more typical of isostatic pressing practice—rather two or more multiple membranes arranged around the powder and resulting pressed body 150 as in FIG. 7. In this case, the internal space between the interior of the frame and the exterior of the fluid-tight bag enclosing the green state powder pressed ceramic body is filled with pressurized fluid F.

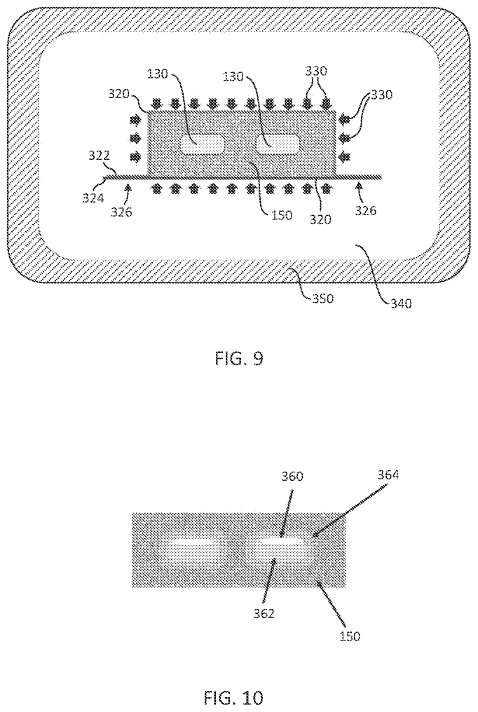

Process steps for one embodiment of demolding green pressed fluidic devices according to this aspect are shown in the flow chart of FIG. 8, and a cross-sectional representation of an isostatic press apparatus for use in performing the process is shown in FIG. 9. With reference to both figures, the process 500 includes step 510 of sealing a green state powder pressed ceramic body 150, with one or more internal passage molds 130 inside, in fluid-tight bag 320. As seen in FIG. 9, the bag 320 can include a top layer 322 and a bottom layer 324 sealed together at a seal region 326, such as by pinching together and heating top and bottom layers 322, 324 which can be formed of polymer. Multiple rows of thermally produced seals can be used in the seal region 326 if desired. Vacuum sealing can be used and is preferred but not required—successful tests have been performed with and without vacuum sealing. The bag is fluid-tight to the fluid 340 in the chamber 350, which can be, for example, water.

Further in FIG. 9, a press chamber 350 holds a fluid which is, in step 512 of the process 500, desirably preheated to a target temperature for melting the mold (for example, to 50° C. for a wax-based mold). In step 514 the bag 320 with the green state powder pressed ceramic body 150 sealed inside is then lowered into the isostatic press chamber fluid 340. Next in step 515, the isostatic press chamber is closed and sealed, and pressure is applied to the chamber fluid (e.g., in the range of 100-600 PSI), producing essentially isostatic pressure on all surfaces of the body 150. In step 516, the pressure and temperature are maintained for a period of time, such as 90 minutes, to melt the material of the passage mold 130.

As mentioned, the passage mold can be a wax-based material. As the green state powder pressed ceramic body 150 is heated by the warm fluid, the passage mold(s) 130 are also heated, and the mold material begins expanding, softening, and melting. The expansion produces an outward force on the interior walls of the passages within the body 150. The outward force is counteracted and/or balanced, at least in part, by the isostatic pressing force, represented by the arrows 330, applied to the exterior surface of the body 150 through the bag 320.

The melted mold material can move into optional ports such as ports IP1, IP2, IP, OP shown in FIGS. 1 and 2, or into vents or other passages, not shown in FIG. 8, specifically provided therefor. Also, as the mold material melts, its viscosity can be reduced to the degree that it can flow into the small gaps between powder granules of the body 150 in the region around the internal passage(s).

After the time period of step 516 is ended, the pressure inside the chamber 350 is reduced to atmospheric pressure in step 518, the chamber is opened and the bag 320 and body 150 are removed in step 522, and the bag 320 is removed from the body 150 in step 524. During steps 522 and 524, the body is preferably kept sufficiently warm (for example, at 50° C. or greater) to prevent re-solidification of the mold material, until any remaining mold material is completely removed, such as by heating the body 150 in an oven (for example, at 175° C., in air), in step 526. While heating, the body can be oriented to allow the mold material to drain out through one or more ports IP1, IP2, IP, OP.

Prior to heating the body 150 in an oven in step 526, the body and the mold material may be in a state general depicted in the cross section of FIG. 9. As shown in FIG. 10, voids 360 may appear due to migration of mold material into ports or vents (not shown) and/or into a region 364 of the body 150 surrounding the internal passages. After the heating of step 526, the mold(s) 130 have been completely removed from the passage(s) P and from the body 150, as shown in the cross section of FIG. 11. As an alternative to heating in an oven as a separate step, the remaining mold material can be volatilized and removed during the early stages of firing the pressed body (prior to or as part of debinding and consolidation of the pressed body) before sintering.

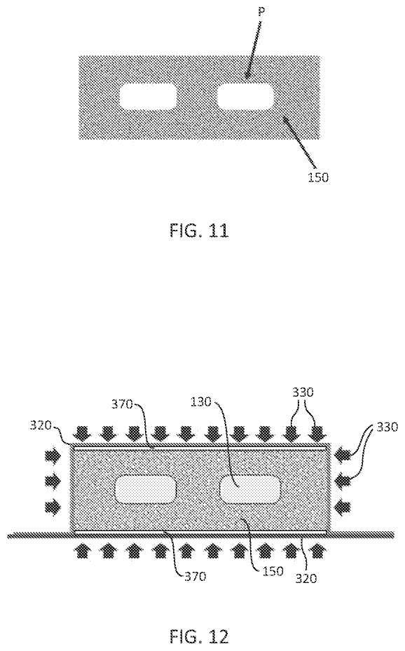

According to another and alternative aspect of the present disclosure shown in the cross section of FIG. 12, force-distribution plates 370 may be positioned between the body 150 and the bag 320. These plates 30, in the form of flexible metal or polymer sheets, for example, 370 can distribute the localized forces of the isostatic pressure across a wider area of the body 150 to prevent any tendency of that pressure to collapse the internal fluid passage(s) during demolding as the material of the mold(s) 130 melts. Such plates can be particularly useful on surfaces of the body which lie parallel to the larger dimension of the passage(s) 130, as shown in FIG. 12.

As discussed above with respect to the embodiment of FIG. 7, heaters may optionally be used, particularly if gas is used as the pressurizing fluid rather than liquid, which may be in addition to or incorporated into force-distribution plates 370, for example.

As also discussed with respect to the embodiment of FIG. 7, the isostatic press chamber 350 of FIG. 9 may similarly be used, alternatively or in addition, to perform the pressing of the SiC powder to form the pressed body 150 as in step 40 of FIG. 3.

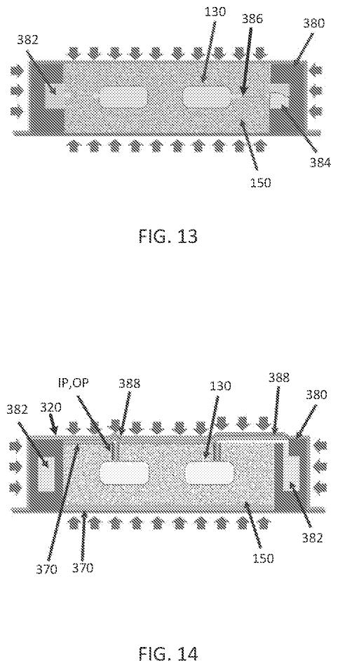

The cross section of FIG. 13 depicts additional or alternative features which can be used to provide for and/or assist with removal of melted mold material, whether in the press apparatus of FIG. 7 or in the isostatic pressing chamber of FIG. 9. As seen in FIG. 13, one or more reservoir frames 380 may be positioned against one or more outer surfaces of the body 150. Reservoir frames 380 include a relatively large surface area in contact with the body 150 and reservoirs 382 within the reservoir frames 380. One or more ports or vents 386 for outflow of mold material lead from the internal passage molds 130 to the reservoirs 382. The surface area at which reservoir frames 380 contact the body 150 transfers pressure to the body 150, while the reservoirs 382 receive melted mold material 384 as the mold material softens and flows.

In another additional or alternative aspect, as an alternative to the one or more ports or vents 386 FIG. 14, one or more ridges 388 or “ridge channels” 388 (ridges which form a channel beneath the ridge) may be included one or more of the force distribution plates 370, to allow for flow of melted mold material along the ridge channel 388 to an associated reservoir frame 380. As shown in the figure, the reservoir frames 380 in this aspect can have full contact with the side of the body 150 against which they are positioned, with an opening into the reservoir on an adjoining face of the reservoir frame 380.

According to yet another alternative embodiment representable by FIGS. 13 and 14, in case a pressure differential is desired to assist in removing the mold but no pathway to the outside of the pressure tight bag 320 and the associated pressure chamber 350 is desired or is available, one or more of the chambers 382 of FIGS. 13 and 14 may be filled in part with a liquid that, when heated, along with the rest of the body 150, will apply a vapor pressure to the mold material from the direction of the one or more of the chambers 382. One or more other chambers 382, 384 contain no liquid and are thus able to receive the melted mold material driven toward these chambers by the vapor pressure.

According to still another alternative embodiment representable by FIGS. 13 and 14, in case a pressure differential is desired to assist in removing the mold but no pathway to the outside of the pressure tight bag 320 and the associated pressure chamber 350 is desired or is available, and in cases where the embodiments shown are used for demolding only and not additionally for the pressing step, one or more of the chambers 382 of FIGS. 13 and 14 may formed of or may include a compressible material such that when the chamber is placed under isostatic pressure together with the body 150, the chamber be compressed, producing a gas pressure on the mold material from the direction of the one or more of the chambers 382. One or more other chambers 382, 384 are not compressible and are thus able to receive the melted mold material driven toward them by the compression of the compressible chambers.

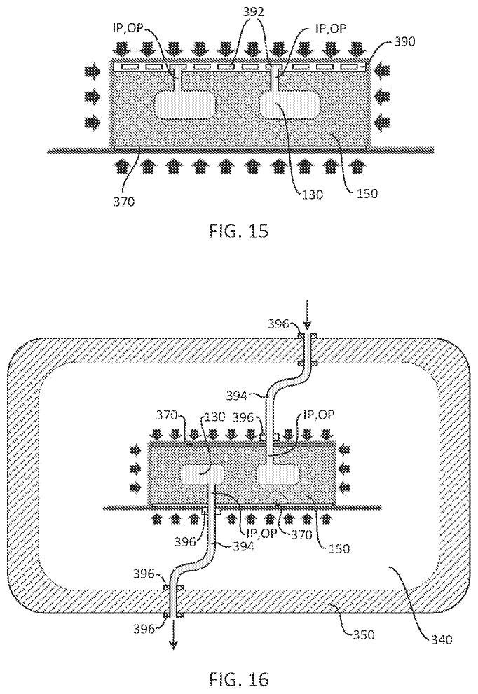

In yet another additional or alternative aspect shown in the cross section of FIG. 15, a force distribution plate 390 with cavities 392 can be employed on one or more surfaces of the body 150. The cavities 392 are interconnected (in a plane other than the cross-section shown) and input or output ports IP, OP are aligned with one or more of the cavities 392. Melted mold material from the passage mold(s) 130 can then flow into the cavities 392 as the mold material softens and flows.

In still another additional or alternative aspect shown in the cross section of FIG. 16, one or more tubes 394, can be used, joined at one end to the input or output ports and extending out through the of the chamber 350, with seals 396 maintaining fluid tightness. In this aspect, pressure can be applied (as represented by the arrow at the top of the figure) or vacuum can be applied (as represented by the arrow at the bottom of the figure), or both to assist in the removal of melted mold material.

### Mold Materials and Mold Formation

As mentioned above, the passage mold can be obtained by molding, machining, 3D printing, or other suitable forming techniques or combinations thereof. The material of the passage mold can be an organic material such as an organic thermoplastic. The mold material may include organic or inorganic particles suspended or otherwise distributed within the material as one way of decreasing expansion during heating/melting. As mentioned, the material of the passage mold is desirably a relatively incompressible material-specifically a material with low rebound after compression relative to the rebound of the pressed SiC powder after compression, as explained above in connection with FIG. 6. Mold materials loaded with particles can exhibit lower rebound after compression. Mold materials which are capable of some degree of non-elastic deformation under compression also naturally tend to have low rebound (e.g., materials with high loss modulus). Polymer substances with little or no cross-linking, for example, and/or materials with some local hardness or brittleness which enables localized fracturing or micro-fracturing upon compression can exhibit low rebound. Useful mold materials can include waxes with suspended particles such as carbon and/or inorganic particles, rosin containing waxes, high modulus brittle thermoplastics, and even organic solids suspended in organic fats such as cocoa powder in cocoa butter—or combinations of these. Low melting point metal alloys also may be useful as mold materials, particularly alloys having low or no expansion on melting.

FIGS. 17-19 are graphs of the experimental determination of compression and/or release curves of various materials. Tests were carried out to characterize the elastic and loss moduli of various materials using an Instron 3400 Series Universal Testing machine that includes compressing (Instron, Norwood, MA, USA). The Instron was configured to apply a known compressive displacement to a sample material held in a die, and then measure the reaction force generated by the sample. The resulting force-displacement relationship was assessed as each sample was controllably compressed (compression phase) and then controllably released from compression (release phase). The Instron measurement was conducted under force conditions configured to mimic the forces experienced by larger SiC fluidic devices during pressing. Since the maximum force that the Instron could produce and that its load cell could sustain was limited to 1200 N, material samples were prepared using a 0.75″ diameter die. Several different wax samples were prepared that were nominally 8 mm thick and 0.75″ diameter, including red wax (McMaster-Carr), stacking wax (Universal Photonics #444), beeswax (McMaster-Carr), bay wax, and Ghirardelli 100% cacao chocolate. Each sample was placed in a 0.75″ diameter die and compressed by the Instron at a fixed rate with compression terminated when the reaction force generated by the sample equaled 1200 N. After compression to a maximum force of 1200 N, the displacement was reduced while continuing to measure the reaction force generated by the sample.

FIG. 17 is a graph of the force-displacement curves for these noted samples. To simplify comparison of the various samples, the force-displacement curve for each sample was shifted so that all release phase curves line up with each other at the moment of initial release. For each sample as the displacement was reduced the reaction force dropped dramatically, but not instantaneously to zero. The curvature of the force-displacement curve to the left as it drops is an indication of how much stored energy is released from the sample during the release phase. The negative values of compression correspond to upward motion of the piston. The plot shows how different samples respond very differently during the release phase. Some samples, such as the red wax and bay wax, provide reaction forces over large displacement distances during the release phase, while others, such as chocolate and stacking wax, rapidly reduce their reaction force with displacement.

The area under the release phase force-displacement curves provides an indication of how much stored energy is released by the sample during the release phase. The point at which the force-displacement curve reaches the horizontal Load=0 N line provides an indication of the spring-back provided by the sample. For example, the spring-back of the chocolate and stacking wax samples was around 0.07 mm. Since the samples were 10-12 mm thick, this corresponds to a spring-back of around 7 μm per mm of sample thickness. Materials that exhibit low spring-back should be good candidates as materials for crack-free pressing of passages in SiC fluidic devices. Pressing experiments show that crack-free SiC fluidic devices can be fabricated using passage molds made from chocolate and stacking wax.

Crack formation is also a function of the spring-back expansion of SiC powder that surrounds the passage mold. Measurements of reaction force vs. compression displacement for SiC powder samples during release phase were also taken. In the experiment, it was determined that force-displacement curve meets the Load=0 N line at a compression of ˜−0.13 mm. Since the samples were 10 mm thick, this corresponds to a spring-back of around 13 μm per mm of sample thickness. The force-displacement curve of the SiC powder sample is plotted over the force-displacement curves of the various material samples in the graph of FIG. 17. Samples with force-displacement curves that fall completely below the SiC powder curve have been used as passage molds and pressed in SiC fluid devices without cracking. Samples with force-displacement curves that fall completely above the SiC powder curve may have cracking after pressing.

FIG. 18 is a graph of the force-displacement curves for different types of stacking waxes. One objective of this additional study was to identify hard waxes (for smooth internal channel sidewalls) that can be pressed without cracking the surrounding SiC powder. The waxes were characterized on the Instron following the approach described above with reference to FIG. 17. FIG. 18 depicts the force-displacement curves during both the compression and release phases for six waxes. The six example waxes tested in this experiment were all procured from Universal Photonics. Other suppliers and other materials for the passage mold may be used if the materials possess the attributes and satisfy the relationships described herein. Samples with steep slopes during the compression phase are harder and expected to provide smooth internal channel sidewall surfaces. The force-displacement curves were shifted left so that all curves overlap on initiation of the release phase. All samples except Unibond 5.0 adhesive and PX-15 B&L pitch have force-displacement curves that fall well under the SiC powder force displacement curve (blue solid line in the plot). In pressing experiments Universal Photonics, Inc. stacking waxes #4, #5, #6, and #444 all produced SiC fluidic devices with no cracks. Other waxes, including Universal Photonics #75175 Holding Wax and Universal Photonics Optical Quality Rosin, have also been shown to yield crack-free SiC fluidic devices after pressing. These other waxes are attractive because they provide high durometer performance that should reduce internal channel sidewall surface roughness.

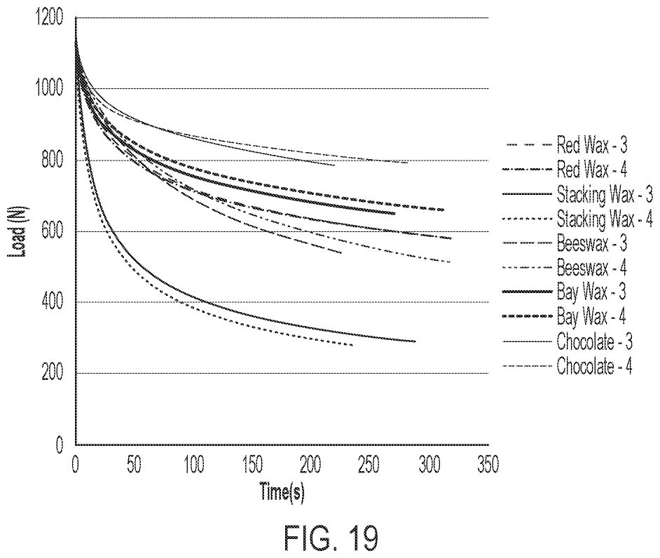

The passage mold 130 can be formed from materials different than the materials identified with reference to FIGS. 17 and 19. In some embodiments, the material of the passage mold 130 has the following properties. Firstly, the passage mold material has a high loss modulus (G″) so that instead of storing energy like a rigid spring-like body, the energy is lost through physical reorganization of the body. Many high loss modulus materials have liquid-like properties that allow them to dissipate energy through reorganization. When the material is physically constrained so that bulk flow is not possible, high loss modulus materials dissipate energy through molecular-scale reorganization and heat generation. Secondly, passage mold material has an elastic (or storage) modulus (G′) that is just low enough to prevent excessive spring-back and cracking after pressing. If the passage mold material satisfies the elastic modulus G′ preference, it is preferable that the passage mold material also has a high hardness to enable formation of smooth internal channel sidewalls after pressing, which tends to directly correlate with an elastic modulus G′ that is as high as possible High elastic modulus (e.g., hard) passage mold materials generate smooth sidewalls by preventing SiC granule penetration during pressing.

FIG. 19 is a graph illustrating the influence of a displacement hold at maximum displacement. Instron characterization of wax sample properties can include a displacement hold at maximum displacement. Measurements show that in this constant displacement configuration the sample reaction force drops rapidly over time. This is an indication that stored energy in the sample is being lost. FIG. 19 provides force-time curves during a hold at constant displacement, showing how the rate of reaction force reduction varies dramatically by sample.

In further embodiments, the process for forming a SiC device for a flow reactor includes a constant displacement hold during the pressing cycle. After completion of the hold, the reaction force of the mold material is reduced so that after pressing is complete its spring-back is similarly reduced. In practice, it is preferred to introduce a hold at constant pressure. If only the mold was being pressed, this would produce a gradual compression of the mold material. In practical SiC fluidic device fabrication, however, the mold is surrounded on all sides by SiC powder. The SiC powder becomes increasingly incompressible at higher pressures, so that during this constant pressure hold additional compression of the mold is minimal. As a result, the passage mold dissipates energy, thereby reducing its spring-back and leading to production of crack-free SiC fluidic devices that may otherwise crack after pressing. It has been determined that a pressing hold of 1 minute after maximum pressure is useful for eliminating SiC fluidic device cracks. The process can have longer or shorter duration pressing holds in other embodiments. Additionally, the pressing hold can include a variable pressure, for example, a hold pressure that increases or decreases during the hold period. In embodiments in which the hold pressure varies, the hold pressure can vary linearly or exponentially during the hold period.

As the mold is heated to be melted and removed, the mold material can potentially expand more than is desirable before sufficiently low viscosity is reached for the mold material to flow away and relieve the pressure of expansion. If the pressure generated during mold removal is excessive, the passage being formed may be damaged. As an additional alternative embodiment addressing this potential issue, a mold may be used which has an outer layer of lower melting material having a melting point than the rest or inner portion of the mold. By selecting a lower melting material having a sufficiently lower melting point then the remainder of the mold, when the mold is heated to remove the mold, the outer layer can transition to low viscosity before the mold as a whole has expanded significantly, and the outer layer can then flow away as the remainder of the mold is further heated and expands then melts, relieving pressure that may otherwise be undesirably high. Melting point separation between the low melting material melting point and the melting of the remainder of the mold is desirably at least 5° C., or even 20° C. or even 40° ° C. but generally not more than 80° C. The outer layer can be formed by a second molding or by dipping or the like.

“Monolithic” as used herein has the meaning provided above (paragraph [0049]). However, Applicants reserve a right to otherwise define monolithic if expressly so stated, such as in the claims, where monolithic may alternatively be defined as a body of sintered polycrystalline ceramic material with a chain of grains having a continuous and uniform distribution through an entirety of the body in any direction, such as when grain growth occurs concurrently during a single sintering cycle, yet where the body may include internal passages, as disclosed herein, and interstitial pores between grains, and optionally where most interstitial pores have a maximum crosswise dimension of less than 5 μm, such as in the range of from 2 to 3 μm, and/or where the body is free of separate components (e.g. halves of the body) bonded to one another at a joint (observable and/or detectible), such as at a joining plane in the case of components prepared via the sandwich assembly approach. A joint may be observable and/or detectible, for example, by the naked eye, microscopic analysis of cross sections, scanning electron microscopy (SEM), far-infrared reflectivity spectroscopy, electron backscatter diffraction (EBSD), surface profilometer measurement after etching, compositional variations through Auger electron spectroscopy (AES), X-ray photoelectron spectroscopy (XPS), and/or x-ray CT scanning. A joint may be indicated by a sharp change in porosity, composition, and/or density of the material in any direction through the body. A joint may also be indicated by a disruption or an incongruity in the distribution of grains through the material.

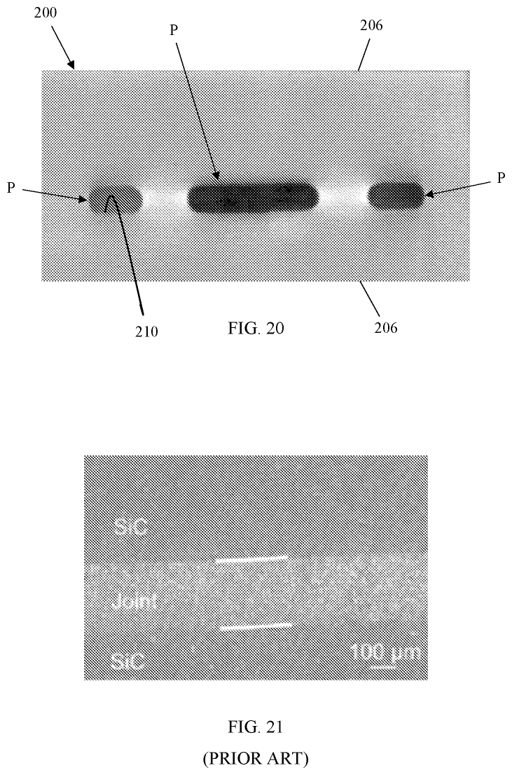

FIG. 20 is an X-ray computed tomography (CT) image of a cross section of the monolithic closed porosity ceramic body 200, for example, along a section plane 202 (FIG. 2), illustrating a microstructure the body 200. Though the body 200 shown in FIG. 2 has a rectangular cuboid shape with a length l, a width w, and a thickness t, the body in further embodiments can have any shape that enables the processes described herein. The width w of the body 200 corresponds to left and right in the view of FIG. 20, and the thickness t of the body 200 corresponds to up and down in the view of FIG. 20. The thickness t is shown extending between opposed major surfaces 206, which in the rectangular embodiment of the body are generally planar opposed surfaces having a larger surface area than other opposed surfaces of the body 200. Three portions of the passage(s) P are shown in the cross-sectional image, including a left portion, a middle portion, and a right portion. As mentioned, the interior surface 210 defines an interior profile that encircles the path of the passage. The intensity of shading used in the CT image corresponds to the density of the material of the body 200. The lighter regions correspond to higher density areas of the body (e.g., areas between passage portion pairs) and the darker regions correspond to lower density areas of the body (e.g., voids defined by passage P). Since the monolithic closed porosity body 200 is formed from a single volume of ceramic particles that is pressed, heated, and sintered according the processes described herein, any density gradients through the body are gradual as shown in the CT image of FIG. 20.

In contrast, ceramic bodies formed by substrate joining techniques in which two or more separate ceramic substrate bodies are joined will invariably have seams or joints. FIG. 21 is a cross-section image of a joint formed using a tape bonding approach known in the art. While some interdiffusion may occur between the joint material and the substrates, the joint is visibly less dense than the surrounding SiC substrates and the density gradient through the joined body at the joint is sharp. This abrupt density variation can produce a weaker mechanical joining of substrates compared to bulk SiC. The lower density joint can also introduce undesirable porosity.

The grains of the sintered polycrystalline ceramic material of the ceramic body 200 in some embodiments have a microstructure with a unimodal (also referred to as monomodal) grain size distribution and a maximum grain size. A unimodal grain size distribution is a grain size distribution with a single distinct peak or mode along the distribution at a specific grain size. A multimodal grain size distribution, in contrast, is a grain size distribution with multiple distinct peaks or modes along the distribution at multiple different grain sizes. In addition to the grain size distribution, the ceramic material in some embodiments has a maximum grain size of less than 20 μm, or even less than 10 μm, 5 μm, or 2 μm. As used herein, a “continuous and uniform distribution” of the chain of grains means that a size and/or spatial relationship among the grains is consistent throughout an entirety of the ceramic material of the body, for example, when comparing the size and spatial relationship among the grains for any two or more arbitrary volumetric sections of the ceramic body, either adjacent to or spaced apart from one another, throughout the ceramic body. A “continuous and uniform distribution” of the chain of grains can also refer to the distribution or quantity of the phase of the SiC material in the ceramic body 200. In some embodiments, a percentage of α-SiC content of the ceramic body 200 is greater than 95, 98, or 99%, and a percentage of β-SiC content of the ceramic body 200 is less than 1% or 0%.

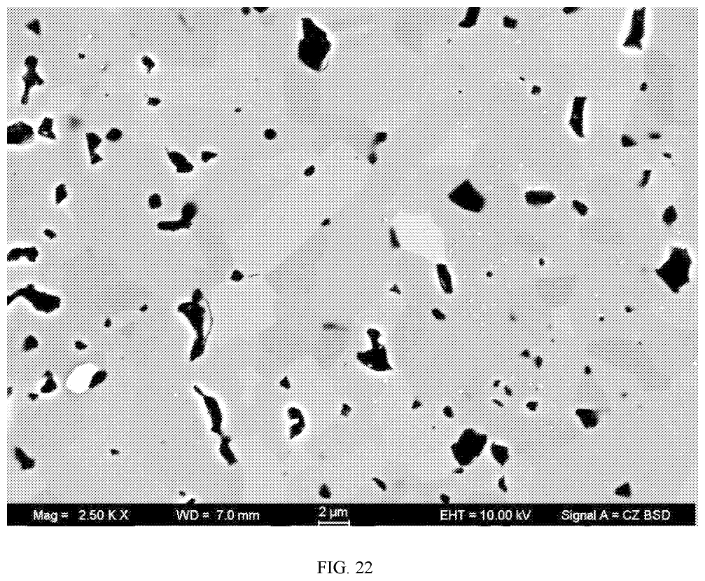

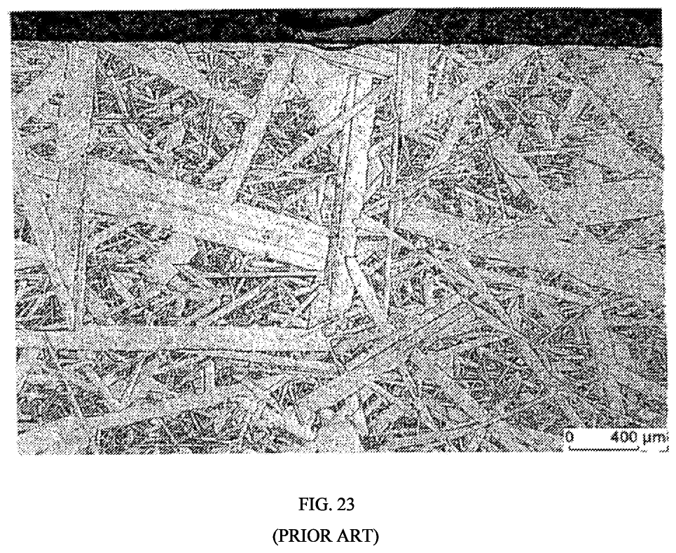

FIG. 22 is an SEM image of a sample of sintered SiC material processed according to the methods of the present disclosure. The individual grains of the SiC material appear as lighter and darker regions in the image. As shown in the image, the grains are organized within the material as a chain of grains having a continuous and uniform distribution through the entirety of the sample shown. FIG. 23 is photomicrograph image of a sample of sintered SiC material produced using the conventional diffusion bonding approach. The ceramic material shown in FIG. 23 includes a mixture of large, coarse grains and small, fine grains distributed throughout the sample in no discernable manner. The distribution of grains in the ceramic body shown in FIG. 23 is indicative of a ceramic material having a bimodal grain size distribution.

The devices disclosed and/or produced by the methods disclosed herein are generally useful in performing any process that involves mixing, separation including reactive separation, extraction, crystallization, precipitation, or otherwise processing fluids or mixtures of fluids, including multiphase mixtures of fluids—and including fluids or mixtures of fluids including multiphase mixtures of fluids that also contain solids—within a microstructure. The processing may include a physical process, a chemical reaction defined as a process that results in the interconversion of organic, inorganic, or both organic and inorganic species, a biochemical process, or any other form of processing. The following non-limiting list of reactions may be performed with the disclosed methods and/or devices: oxidation; reduction; substitution; elimination; addition; ligand exchange; metal exchange; and ion exchange. More specifically, reactions of any of the following non-limiting list may be performed with the disclosed methods and/or devices: polymerisation; alkylation; dealkylation; nitration; peroxidation; sulfoxidation; epoxidation; ammoxidation; hydrogenation; dehydrogenation; organometallic reactions; precious metal chemistry/homogeneous catalyst reactions; carbonylation; thiocarbonylation; alkoxylation; halogenation; dehydrohalogenation; dehalogenation; hydroformylation; carboxylation; decarboxylation; amination; arylation; peptide coupling; aldol condensation; cyclocondensation; dehydrocyclization; esterification; amidation; heterocyclic synthesis; dehydration; alcoholysis; hydrolysis; ammonolysis; etherification; enzymatic synthesis; ketalization; saponification; isomerisation; quaternization; formylation; phase transfer reactions; silylations; nitrile synthesis; phosphorylation; ozonolysis; azide chemistry; metathesis; hydrosilylation; coupling reactions; and enzymatic reactions.

The process disclosed and the structures producible can be extended to additional fields of application, in that a SiC structure can be provided, the structure comprising a monolithic closed-porosity SiC body; and a tortuous fluid passage extending within the SiC body, the tortuous fluid passage having an interior surface, with the interior surface having a surface roughness of less than 10 μm Ra, or in the range of from 0.1 to 5 μm Ra, or in the range of from 0.1 to 1 μm Ra.

The SiC of the structure has a density of at least 95, 96, 97, 98, or 99% of the theoretical maximum density (or the average of any such, in the case of multiple) for SiC. The SiC of the structure has an open porosity of less than 1%, less than 0.5%, or less than 0.1%. The SiC of the structure has a closed porosity of less than 3%, or less than 1.5%, or even less than 0.5%.

An internal pressure resistance of the structure under pressurized water testing can be at least 50 bar, or at least 100 bar, or at least 150 bar.

The SiC structure can have an interior surface of tortuous fluid passage comprising a floor and a ceiling separated by a height h and two opposing sidewalls joining the floor and the ceiling, with the sidewalls separated by a width w measured perpendicular to the height h and at a position corresponding to one-half of the height h wherein the height h of the tortuous fluid passage is in the range of from 0.1 to 20 mm. The height h of the tortuous fluid passage can be in the range of from 0.2 to 15 mm, or in the range of from 0.3 to 12 mm.

The process for forming a SiC structure with an internal passage can comprise positioning a positive fluid passage mold of a passage having a tortuous shape within a volume of binder-coated SiC powder; pressing the volume of SiC powder with the mold inside to form a pressed body; heating the pressed body to remove the mold; and sintering the pressed body to form a monolithic SiC structure having a tortuous fluid passage within. Pressing the volume of SiC powder with the mold inside can comprise uniaxial pressing or isostatic pressing. Heating the pressed body to remove the mold can comprise pressing the pressed body while heating the pressed body. The process can further comprise debinding the pressed body before sintering the pressed body. The process can further comprise forming a positive passage mold of a passage having a tortuous shape by molding and/or 3-D printing the passage mold.

The process can further comprise forming a positive passage mold having an outer layer of lower melting material, the lower melting material having a melting point lower than a melting point of a remainder of the positive passage mold. The melting point of the lower melting material can be lower than the melting point of the remainder of the positive passage mold by at least 5° C.

A first aspect of the present disclosure includes a fluid device, comprising a monolithic closed-porosity ceramic body; and a tortuous fluid passage extending through the ceramic body, the tortuous fluid passage having a smooth interior surface, wherein a material of the ceramic body has a continuous and uniform distribution of grains at least between opposed major surfaces of the ceramic body.

A second aspect of the present disclosure includes a fluid device according to the first aspect, wherein the grains of the material have a grain size of less than 10 μm.

A third aspect of the present disclosure includes a fluid device according to the first aspect, wherein the smooth interior surface has a surface roughness of less than 10 μm Ra.

A fourth aspect of the present disclosure includes a fluid device according to the first aspect, wherein the material of the ceramic body is silicon carbide (SiC).

A fifth aspect of the present disclosure includes a fluid device according to the fourth aspect, wherein the density of the SiC is at least 95% of a theoretical maximum density of SiC.

A sixth aspect of the present disclosure includes a fluid device according to the fifth aspect, wherein the material of the ceramic body has an open porosity of less than 1%.

A seventh aspect of the present disclosure includes a fluid device according to the first aspect, wherein an internal pressure resistance of the ceramic body under pressurized water testing is at least 50 bar.

An eighth aspect of the present disclosure includes a fluid device according to the first aspect, wherein the interior surface of tortuous fluid passage comprises a floor and a ceiling separated by a height h and two opposing sidewalls joining the floor and the ceiling, the sidewalls separated by a width w measured perpendicular to the height h and at a position corresponding to one-half of the height h, and wherein the height h of the tortuous fluid passage is in the range of from 0.1 to 20 mm.

A ninth aspect of the present disclosure includes a fluid device according to the eighth aspect, wherein the height h of the tortuous fluid passage is in the range of from 0.2 to 15 mm.

A tenth aspect of the present disclosure includes a fluid device according to the eighth aspect, wherein the interior surface at an intersection of the sidewalls and the floor has a radius of curvature in the range of 0.1 to 3 mm.

An eleventh aspect of the present disclosure includes a process for forming a fluid device, comprising positioning a positive passage mold of a passage having a tortuous shape within a volume of binder-coated ceramic powder; pressing the volume of binder-coated ceramic powder with the positive passage mold inside to form a pressed body; heating the pressed body to remove the positive passage mold; and sintering the pressed body to form a high density, closed-porosity ceramic body having a tortuous fluid passage extending therethrough, wherein a relationship between a first stability characteristic of the volume of binder-coated ceramic powder and a second stability characteristic of the positive passage mold prevents discontinuities in the pressed body after pressing and/or during heating.

A twelfth aspect of the present disclosure includes a process according to the eleventh aspect, wherein the first stability characteristic includes a first release displacement and the second stability characteristic includes a second release displacement that is less than the first release displacement after pressing.

A thirteenth aspect of the present disclosure includes a process according to the eleventh aspect, wherein the first stability characteristic includes a first release displacement and the second stability characteristic includes a second release displacement that is greater than the first release displacement after pressing.

A fourteenth aspect of the present disclosure includes a process according to the thirteenth aspect, wherein the first stability characteristic further includes a binder strength of the binder-coated ceramic powder, the binder strength configured to counteract a release force of the positive passage mold on the pressed body.

A fifteenth aspect of the present disclosure includes a process according to the eleventh aspect, wherein the first stability characteristic includes a binder strength of the binder-coated ceramic powder, the binder strength configured to counteract a force of the positive passage mold on the pressed body during heating.

A sixteenth aspect of the present disclosure includes a process according to the eleventh aspect, wherein pressing the volume of binder-coated ceramic powder with the mold inside to form a pressed body comprises uniaxial pressing.

A seventeenth aspect of the present disclosure includes a process according to the eleventh aspect, wherein pressing the volume of binder-coated ceramic powder with the mold inside to form a pressed body comprises isostatic pressing.

An eighteenth aspect of the present disclosure includes a process according to the eleventh aspect, wherein heating the pressed body to remove the mold comprises pressing the pressed body while heating the pressed body.

A nineteenth aspect of the present disclosure includes a process according to the eleventh aspect, further comprising forming a positive passage mold of a passage having a tortuous shape by molding the passage mold.

A twentieth aspect of the present disclosure includes a process according to the eleventh aspect, further comprising forming a positive passage mold having an outer layer of lower melting material, the lower melting material having a melting point lower than a melting point of a remainder of the positive passage mold.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

What is claimed is:

1. A fluid device, comprising:
a monolithic closed-porosity ceramic body; and
a tortuous fluid passage extending through the ceramic body, the tortuous fluid passage having a smooth interior surface,
wherein a material of the ceramic body has a continuous and uniform distribution of grains at least between opposed major surfaces of the ceramic body.

2. The fluid device of claim 1, wherein the grains of the material have a grain size of less than 10 μm.

3. The fluid device of claim 1, wherein the smooth interior surface has a surface roughness of less than 10 μm Ra.

4. The fluid device of claim 1, wherein the material of the ceramic body is silicon carbide (SIC).

5. The fluid device of claim 4, wherein the density of the SiC is at least 95% of a theoretical maximum density of SiC.

6. The fluid device of claim 5, wherein the material of the ceramic body has an open porosity of less than 1%.

7. The fluid device of claim 1, wherein an internal pressure resistance of the ceramic body under pressurized water testing is at least 50 bar.

8. The fluid device of claim 1, wherein the interior surface of tortuous fluid passage comprises a floor and a ceiling separated by a height h and two opposing sidewalls joining the floor and the ceiling, the sidewalls separated by a width w measured perpendicular to the height h and at a position corresponding to one-half of the height h, and wherein the height h of the tortuous fluid passage is in the range of from 0.1 to 20 mm.

9. The fluid device of claim 8, wherein the height h of the tortuous fluid passage is in the range of from 0.2 to 15 mm.

10. The fluid device of claim 8, wherein the interior surface at an intersection of the sidewalls and the floor has a radius of curvature in the range of 0.1 to 3 mm.

11. A process for forming a fluid device, comprising:
positioning a positive passage mold of a passage having a tortuous shape within a volume of binder-coated ceramic powder;
pressing the volume of binder-coated ceramic powder with the positive passage mold inside to form a pressed body;
heating the pressed body to remove the positive passage mold; and
sintering the pressed body to form a high density, closed-porosity ceramic body having a tortuous fluid passage extending therethrough,
wherein a relationship between a first stability characteristic of the volume of binder-coated ceramic powder and a second stability characteristic of the positive passage mold prevents discontinuities in the pressed body after pressing and/or during heating.

12. The process according to claim 11, wherein the first stability characteristic includes a first release displacement and the second stability characteristic includes a second release displacement that is less than the first release displacement after pressing.

13. The process according to claim 11, wherein the first stability characteristic includes a first release displacement and the second stability characteristic includes a second release displacement that is greater than the first release displacement after pressing.

14. The process according to claim 13, wherein the first stability characteristic further includes a binder strength of the binder-coated ceramic powder, the binder strength configured to counteract a release force of the positive passage mold on the pressed body.

15. The process according to claim 11, wherein the first stability characteristic includes a binder strength of the binder-coated ceramic powder, the binder strength configured to counteract a force of the positive passage mold on the pressed body during heating.

16. The process according to claim 11, wherein pressing the volume of binder-coated ceramic powder with the mold inside to form a pressed body comprises uniaxial pressing.

17. The process according to claim 11, wherein pressing the volume of binder-coated ceramic powder with the mold inside to form a pressed body comprises isostatic pressing.

18. The process according to claim 11, wherein heating the pressed body to remove the mold comprises pressing the pressed body while heating the pressed body.

19. The process according to claim 11, further comprising forming a positive passage mold of a passage having a tortuous shape by molding the passage mold.

20. The process according to claim 11, further comprising forming a positive passage mold having an outer layer of lower melting material, the lower melting material having a melting point lower than a melting point of a remainder of the positive passage mold.
